(19) United States
(12) Patent Application Publication
(10) Pub. No.: US 2015/0070739 A1
(43) Pub. Date: Mar. 12, 2015

(54) METHODS AND DEVICES FOR COHERENT OPTICAL DATA DETECTION AND COHERENT DATA CHANNEL MODULATION

(71) Applicant: Akonia Holographics, LLC, Longmont, CO (US)

(72) Inventors: Mark R. AYRES, Boulder, CO (US); Kenneth E. ANDERSON, Boulder, CO (US); David C. PRUETT, Longmont, CO (US); Will A. LOECHEL, Longmont, CO (US)

(21) Appl. No.: 14/484,060

(22) Filed: Sep. 11, 2014

Related U.S. Application Data
(60) Provisional application No. 61/876,725, filed on Sep. 11, 2013.
(60) Provisional application No. 61/941,974, filed on Feb. 19, 2014.
(60) Provisional application No. 61/986,083, filed on Apr. 29, 2014.

(51) Int. Cl. G03H 1/22

(52) U.S. Cl. CPC G03H 1/2202; G03H 1/2286
USPC 359/32

(57) ABSTRACT

Methods and devices for coherent holographic data channel techniques are presented. Coherent techniques for data detection generally include homodyne and heterodyne detection. Techniques for Quadrature homodyne detection (QHD), Enhanced resampling quadrature homodyne detection (ERQHD), N-rature homodyne detection (NHD), and local oscillator fringe demodulation are presented. Coherent detection techniques in turn enable coherent channel modulation techniques such as phase modulation (including binary phase shift keying, or BPSK; phase quadrature holographic multiplexing, or QPSK; and quadrature amplitude modulation, or QAM). Coherent detection may also enable or improve the performance of other channel techniques such as Partial response maximum likelihood (PRML), the various classes of extended PRML, and of Noise predictive maximum likelihood (NPML) detection.

### CROSS-REFERENCE TO RELATED APPLICATIONS

The present application claims priority to U.S. patent application Nos. 61/876,725 filed Sep. 11, 2013 and titled MULTI-TERABYTE HOLOGRAPHIC DATA STORAGE SYSTEMS; 61/941,974 filed Feb. 19, 2014 and titled REFLECTIVE HOLOGRAPHIC STORAGE MEDIUM; and 61/986,083 filed Apr. 29, 2014 and titled N-RATURE HOMODYNE DETECTION. The entire disclosures of the aforementioned US patent applications are incorporated herein by reference.

In addition, the entire disclosures of U.S. patent application Ser. No. 11/562,533 filed Nov. 22, 2006 and titled METHOD FOR HOLOGRAPHIC DATA RETRIEVAL BY QUADRATURE HOMODYNE DETECTION, which issued as U.S. Pat. No. 7,623,279 on Nov. 24, 2009; and Ser. No. 11/069,007 filed Feb. 28, 2005 and titled PROCESSING DATA PIXELS IN A HOLOGRAPHIC DATA STORAGE SYSTEM, which issued as U.S. Pat. No. 7,848,595 on Dec. 7, 2010, are incorporated herein by reference.

### BACKGROUND

Demand for increased data storage density and data transfer rate continues to grow, and holographic data storage offers advantages in storage density and transfer rate compared to competing methods. However, holographic data storage can be limited by relatively low signal to noise ratio (SNR) and relatively high bit-error rates for data recovered therefrom. Limitations related to SNR and bit-error rates can be exacerbated where data is stored at very high density.

In order to facilitate reliable recovery of stored data, some storage capacity is generally devoted to error correction and duplication of stored data, and low SNR and high bit-error rate generally increase the need for such error correction and data duplication. Thus the relatively low SNR and high bit-error rates associated with recovery of holographic data diminish data density advantages of holographic data storage. In addition, decreased SNR and increased bit-error effects are magnified by some multiplexing methods used to increase holographic data storage density.

Accordingly, techniques for increasing SNR and reducing bit-error rate when recovering stored holographic data are needed. Similarly, multiplexing methods compatible with data recovery techniques that enjoy high SNR and low bit-error rate are required to more fully exploit benefits of holographic data storage.

### BRIEF DESCRIPTION OF THE DRAWINGS

FIG. 1 illustrates schematic views a) and b) of a device adapted to perform coherent holographic data channel techniques according to an embodiment.

FIG. 2 shows quadrature image pair simulations of a PSK-encoded hologram recovered with a local oscillator in a 0° phase state and in a 90° phase state according to an embodiment.

FIG. 3 shows two cross correlation peak strength maps for the images shown in FIG. 2, according to an embodiment.

FIG. 4 shows an image produced by a combination of the quadrature image pair illustrated in FIG. 2, according to an embodiment.

FIG. 5 is a flow chart illustrating of a method of performing QHD absent enhanced resampling.

FIG. 6 is a flow chart illustrating a method of performing ERQHD according to an embodiment.

FIG. 7a is a graph comparing theoretical signal to noise plots for various coherent holographic data channel techniques according to embodiments of the present invention.

FIG. 7b is a graph comparing actual signal to noise plots for various coherent holographic data channel techniques according to embodiments of the present invention.

FIG. 8 is a map of Δ\hat{φ} estimate derived from a Δφ calibration page according to an embodiment.

FIG. 9 is a graph showing plots of SNR vs kx for a standard algorithm compared to a fringe demodulated algorithm according to an embodiment.

FIG. 10 illustrates a PR1 channel represented by a discrete convolution according to an embodiment.

FIG. 11 illustrates a two dimensional generalization of PR1 according to an embodiment.

FIG. 12a is a graph showing a plot of single sinc response of a rectangular aperture according to an embodiment.

FIG. 12b is a graph showing a plot of double sinc response of equalized aperture according to an embodiment.

### DETAILED DESCRIPTION

Homodyne detection comprises a method of blending a coherent reference field (referred to as the local oscillator in the literature) with a signal and detecting the interference pattern between the two. This has an effect of amplifying the signal, eliminating nonlinear effects of coherent noise, and allowing detection of phase as well as amplitude. Formerly, homodyne detection required careful phase control of the local oscillator and the signal, requiring complex adaptive optics and/or phase servo loops. Conversely, embodiments of the present invention include algorithms that allow homodyne detection to be performed simply by combining two or more blended signals with relative phase changes. In some embodiments, homodyne detection according to the present invention boosts signal to noise ratio (SNR) enough to at least double user capacity, as well as providing a host of other benefits.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

The term “data pattern,” as used in this specification and appended claims, refers to a two-dimensional array of binary values. The binary values are typically, but not necessarily, ones and zeros. A modulated data pattern refers to a data pattern as it appears on an image of an SLM.

The term “reserved block pattern,” as used in this specification and appended claims, refers to a data pattern corresponding to a reserved block. For example, an 8×8 array of ones and zeroes defining the pixel values within a reserved block is referred to as a reserved block pattern.

The term “reserved block sample grid,” as used in this specification and appended claims, refers to a set of positions corresponding to centers of reserved blocks. For example, a grid with spacing of 64×64 SLM pixels with each grid point corresponding to the center of a reserved block.

### Homodyne Detection

### Apparatus and Operational Methods

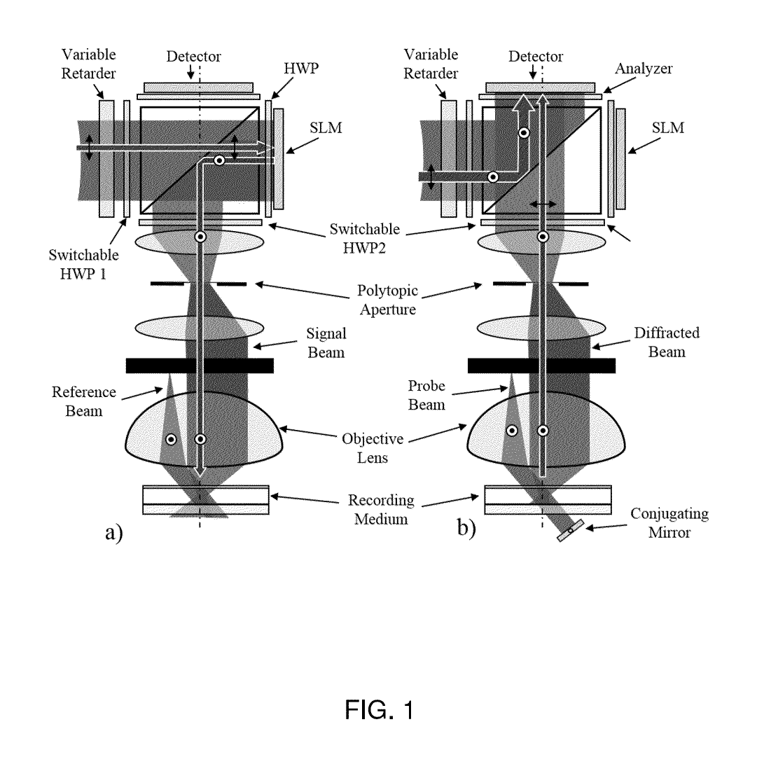

FIG. 1, views a) and b), illustrates an exemplary embodiment of a device configured for implementing coherent channel techniques in accordance with embodiments of the present invention. FIG. 1, view a) indicates the beam paths during a recording operation, while FIG. 1, view b), shows them during a recovery operation. Most elements are common to both beam paths.

### Recording Operation

In the embodiment illustrated in FIG. 1, views a) and b), an architecture is shown that may be used to practice the invention in conjunction with angle-polytopic multiplexing, phase conjugate recovery, and dynamic aperture multiplexing. In the figure, the SLM implements binary PSK modulation with the aid of the half wave plate (HWP) adjacent to it. In FIG. 1, view a), the variable retarder is located in the path of the collimated beam used to illuminate the SLM. In another embodiment, the variable retarder is located in the reference beam arm instead of the signal beam arm. In any case, the variable retarder used for writing quadrature-multiplexed holograms may be the same variable retarder used for QHD during a recovery operation; and the local oscillator beam used during recovery may derive from the same optical path as the SLM illumination beam used for recording. Utilizing the apparatus of FIG. 1, view a), the process of sequentially recording a quadrature-multiplexed hologram pair proceeds as follows:
1) Select the desired medium (r, θ) location and reference beam angle.
2) Configure switchable HWP 1 to transmit p-polarized light so as to illuminate the SLM.
3) Configure switchable HWP 2 to transmit s-polarized light to the recording medium.
4) Set the variable retarder to a first phase state and compose the I data page image on the SLM.
5) Open and close the shutter (not shown) to expose the I hologram.
6) Set the variable retarder to a second phase state and compose the Q data page image on the SLM.
7) Open and close the shutter to expose the Q hologram.

So long as the wavelength, the apparatus, and the recording medium are stable during the interval including both exposures, two holograms thusly written will maintain a quadrature relationship for each of their respective fringe components. To this end, it is advantageous if the exposures are completed in the smallest practical interval of time. However, the stability requirements are not significantly different than those needed for holography generally. In some embodiments, the variable retarder is a liquid crystal-based device. In some embodiments, the variable retarder is an electro-optical device. In some embodiments, the variable retarder is a mirror mounted to a piezoelectric actuator (in such an embodiment, the variable retarder is reflective, not transmissive as shown in FIG. 1, views a) and b).

In embodiments recording higher-order PSK or QAM signals, more than two exposures may be performed.

### Recorded Signal DC Blocking

In some embodiments, a filtering operation is performed to suppress residual DC component of the signal beam during recording. This may be beneficial if the SLM produces a significant DC component due to manufacturing or alignment tolerances. DC blocking may be effected by placing a stop in the DC location of a Fourier plane, for example a small opaque dot in the center of the polytopic aperture. DC blocking may alternatively be effected with an angle filter, e.g., with a multilayer thin-film coating that selectively reflects very low incidence angles (near DC) while transmitting other angles.

### Recorded Phase Changing

In some embodiments, different first and second phase states are used while quadrature hologram pairs are recorded within a book. For example, the sequence of first phase states may correspond to 0°, 10°, 20°, . . . while the second phase state sequence is to 90°, 100°, 110° . . . . In this manner, a phase difference of 90° is maintained within each pair, but the absolute phase of the signal beam within the book changes so as to prevent the coherent build-up of pixel-to-pixel noise gratings within the medium.

### Recovery Operation

Configuration for a recovery operation in one embodiment is shown in FIG. 1, view b). Using this apparatus, the sequence of operations for performing QHD or NHD recovery proceeds as follows:
1) Select the desired medium (r, θ) location and reference beam angle.
2) Configure switchable HWP 1 to transmit s-polarized light so as to illuminate the detector, forming the local oscillator beam.
3) Configure switchable HWP 2 to transmit p-polarized diffracted light to the detector.
4) Configure the conjugating mirror to retro-reflect the probe beam, thus forming a phase-conjugated replica of the recording reference beam.
5) Set the variable retarder to a first phase state.
6) Open and close the shutter (not shown) to detect the I_{A} detector image.
7) Set the variable retarder to a second phase state.
8) Open and close the shutter to detect the I_{B} detector image.

For n-rature detection, steps (5) and (6) are repeated for the C detector image, etc. . . . . The detector images so collected are stored in memory and subsequently processed according to the desired embodiment of the invention.

### Local Oscillator Mixing

In the illustrated embodiment, the signal and local oscillator are incident upon the analyzer in orthogonal linear polarizations. The analyzer is a linear polarizer with its axis oriented so as to transmit components of both the signal and the local oscillator, thereby projecting them onto a common polarization axis. Orientation of the analyzer polarization axis may be used to control the mixing ratio of the signal and local oscillator. In some embodiments, the orientation is set to favor the signal beam, e.g., a 90% signal to 10% local oscillator mixing ratio.

In other embodiments, recording and recovery is performed in architectures substantially different than that of FIG. 1, views a) and b).

### Quadrature Homodyne Detection (QHD)

This section outlines a method of QHD in the absence of enhanced resampling, as described in [1].

### Quadrature Image Recovery

Using the configuration illustrated in FIG. 1, view b), two different images of a hologram may be recovered which bear a quadrature relationship to each other. Since the data and the local oscillator are propagating along the same optical axis, the difference wavefront Δφ(x, y) between the holographic signal carrier and the local oscillator will contain only slowly varying components, producing slowly varying fringes.

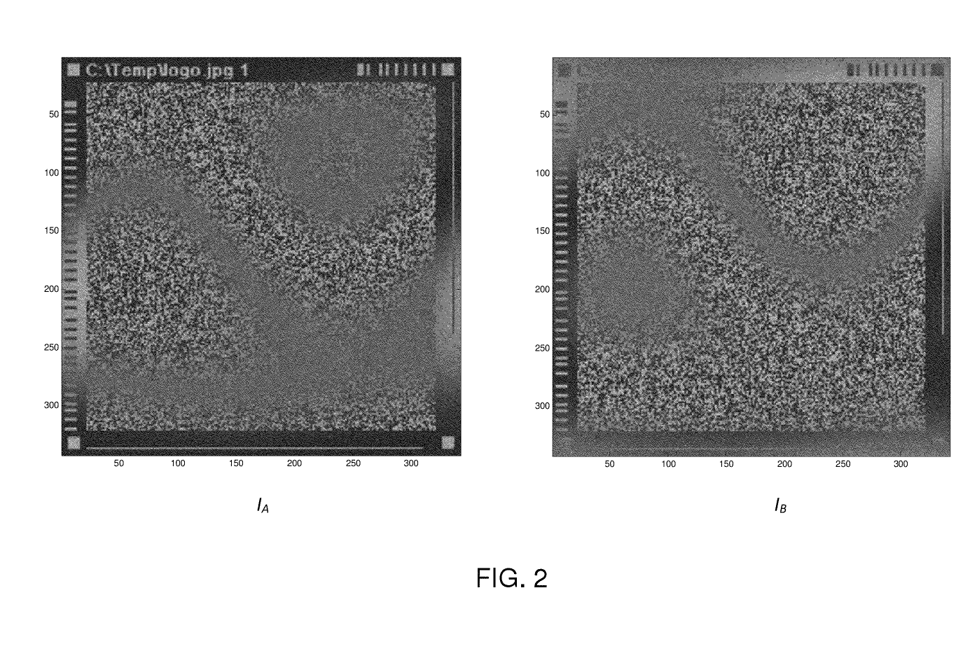

FIG. 2 illustrates I_{A} and I_{B} quadrature image simulations of a PSK-encoded hologram recovered with a local oscillator in each of two phase states (0° and 90°). The first image of FIG. 2, I_{A}, shows the simulated detector intensity when the switchable retarder is in the 0° phase state, and the second image, I_{B}, corresponds to the 90° state.

The simulation uses a local oscillator with intensity 100 times that of the hologram, which has the effect of amplifying the signal by 20. Because of the 90° phase change, the entire fringe pattern has also shifted by 90° so that regions of low contrast in the I_{A} image are high contrast in the I_{B} image, and vice-versa. Thus, the two images contain all the information needed to recover the data.

Estimating Δφ(x, y)

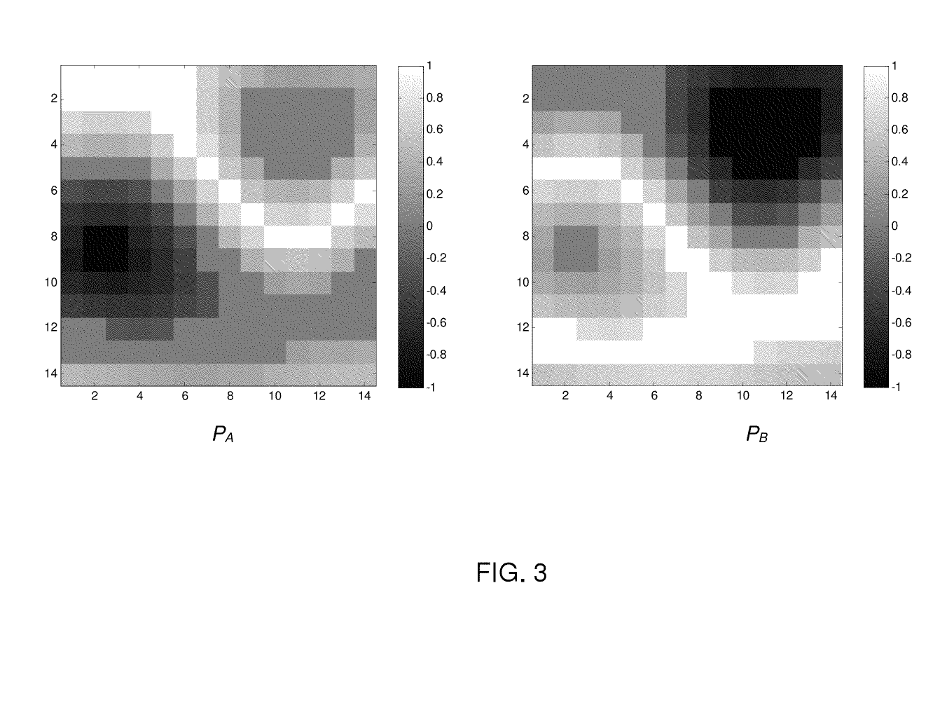

If the hologram contains reserved block patterns as described in [2], then the quadrature image pair also contains all the information necessary to determine Δφ(x, y) Recalling the image alignment measurement method of [2], a cross correlation operation is performed between a portion of the detected image and a corresponding reserved block pattern. FIG. 3 shows normalized cross correlation peak strength maps P_{A} and P_{B} for the simulated I_{A} and I_{B} images of FIG. 2, respectively. Comparing FIG. 2 with FIG. 3, it is apparent that the regions that are in high contrast and non-inverted show large positive peak strength values (approaching +1). Similarly, inverted regions with high contrast have large negative peak strength values approaching −1. The peak strength maps thus constitute contrast information, measuring the contrast (including polarity) of the SLM pixel images regionally. Together, the two peak strength maps represent quadrature projections of Δφ(x, y) onto the locally-varying recovery phase basis. It may be estimated by the expression

Δ\hat{φ}(x,y)=tan⁻¹[P_{B}(x,y),P_{A}(x,y)] (1)

where tan⁻¹ is the four-quadrant arctangent.

The peak strength maps are sampled only at the locations of the reserved blocks. These maps are then up-sampled to positions between the reserved blocks. In one embodiment this is performed using a simple bilinear interpolation function.

### Quadrature Image Combination

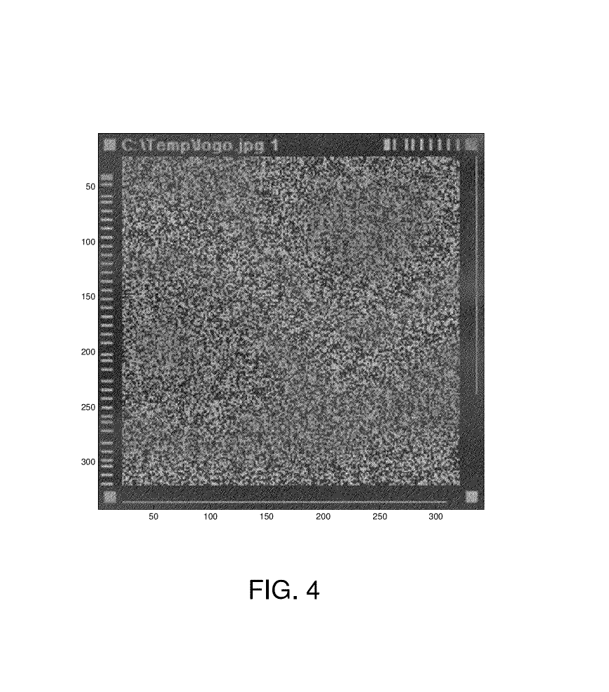

Following a derivation here omitted for brevity [3], we find the rule for optimally combining the I_{A} and I_{B} images to be

$$\begin{matrix}{\hat{E}}_{S} ( x , y ) = cos [ Δ φ ( x , y ) ] {\tilde{I}}_{A} ( x , y ) + sin [ Δ φ ( x , y ) ] {\tilde{I}}_{B} ( x , y ) \\ = \frac{{P}_{A} ( x , y )}{{( {P}_{A}^{2} ( x , y ) + {P}_{B}^{2} ( x , y ) )}^{1 / 2}} {\tilde{I}}_{A} ( x , y ) + \\ = \frac{{P}_{B} ( x , y )}{{( {P}_{A}^{2} ( x , y ) + {P}_{B}^{2} ( x , y ) )}^{1 / 2}} {\tilde{I}}_{B} ( x , y )\end{matrix} \qquad ( 2 )$$

where Ê_{S} is the estimated signal field, and Ĩ_{A} and Ĩ_{B} are (potentially modified) versions of the quadrature images (see Detector Image Modification, below). In this form, it can be seen that the estimate simply combines the two images in proportion to their local contrast, as measured by cross correlation peak strength. The negative sign of the peak will restore the correct polarity in the inverted regions, and the denominator will normalize local variations in image intensity. FIG. 4 shows an image produced by combination of the quadrature image pair of FIG. 2, showing high-contrast non-inverted data throughout.

### Enhanced Resampling Quadrature Homodyne Detection Embodiments

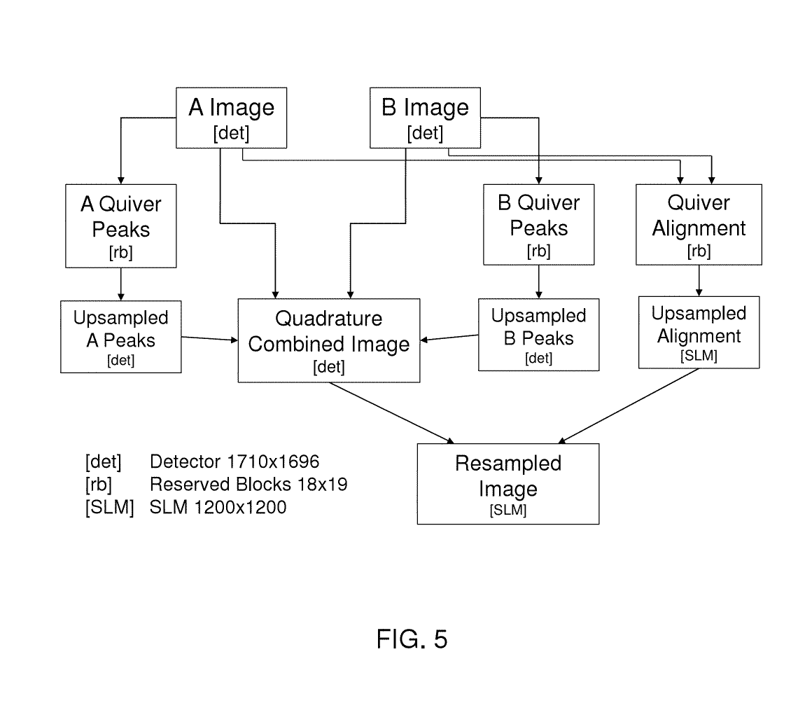

Embodiments of enhanced resampling quadrature homodyne detection (ERQHD) are species of quadrature homodyne detection (QHD). Embodiments of ERQHD include a quadrature image recombination operation combined with a pixel resampling process. FIG. 5 illustrates operations in a generic embodiment of QHD. As shown in FIG. 5, each block represents a data array containing data associated with the a process operation, along with the size/resolution of the data array. Arrays marked with size/resolution “[det]” in FIG. 5 indicate that the data therein correspond to detector pixels, and the data array typically has size equal to that of the detector array, e.g., 1710 rows by 1696 columns of pixels in an exemplary embodiment. Data arrays marked with size/resolution “[SLM]” indicate that the data therein correspond to SLM pixels, typically with data array size equal to the SLM size, e.g., 1200 rows by 1200 columns of pixels in an exemplary embodiment. Typically, a detector has more pixels than a corresponding SLM since the detector must oversample the SLM in order to resolve a modulated data pattern.

Data arrays marked with size/resolution “[rb]” indicate that the data therein correspond to reserved blocks, which are known data patterns embedded within the holographic data page format. These data arrays would have, e.g., 18 rows by 19 columns of entries corresponding to the 18×19 reserved block sample grid of an exemplary data page.

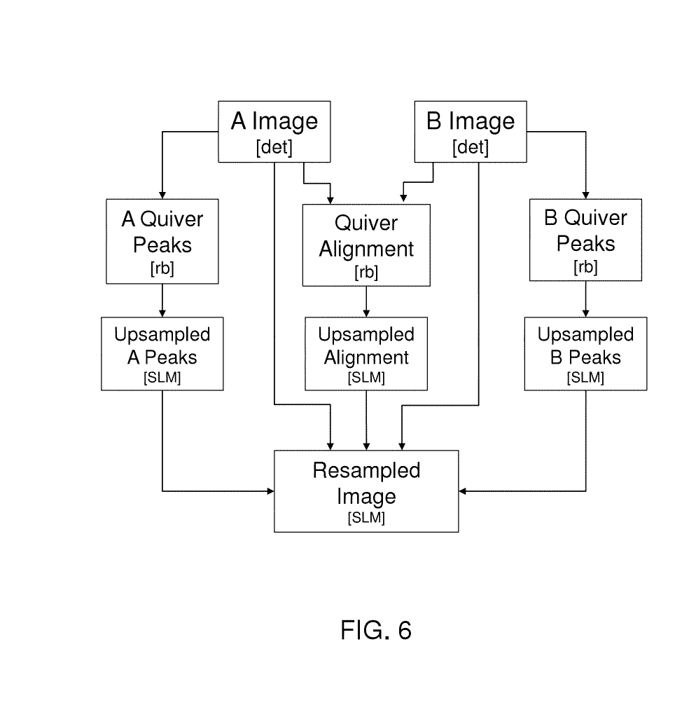

FIG. 5 is a flow chart illustrating a method of QHD absent enhanced resampling. The QHD method illustrated in FIG. 5 includes operations of upsampling the A and B Quiver Peaks from the [rb] resolution to the [det] resolution, as well as an operation of upsampling the Quiver Alignment from the [rb] resolution to the [SLM] resolution. The upsampled A and B Peaks are subsequently used to produce the Quadrature Combined Image at the [det] resolution. FIG. 6, by contrast, illustrates an exemplary embodiment of a method of ERQHD in which the A and B Quiver Peaks are instead upsampled to the [SLM] resolution, and the operation of producing the Quadrature Combined Image is omitted.

Instantiation of a QHD process in a form of ERQHD, including, but not limited to embodiments such as illustrated in FIG. 6, may confer several advantages over a QHD process in the absence of enhanced resampling illustrated in FIG. 5:

1) Upsampling from reserved blocks ([rb]) to SLM ([SLM]) resolution is computationally simpler than upsampling to detector ([det]) resolution because the reserved blocks may be positioned on a rectilinear grid within the SLM image. Upsampling may thus be performed by relatively simple processes such as inserting an integral number of values in each dimension, e.g., using a bi-linear interpolation algorithm. Upsampling from the reserved block to the detector resolution, by contrast, involves upsampling reserved block information that does NOT generally lie on a rectilinear grid due to real-world image distortions, and has an upsampling ratio that is not only non-integer, but one that varies throughout the image. Thus the process of upsampling to SLM resolution may be both simpler and more accurate than upsampling to detector resolution.

2) The memory size to store SLM resolution data arrays is typically smaller than that to store detector resolution data arrays.

3) Reserved block ([rb]) to SLM ([SLM]) upsampling is required in both cases in order to generate the Upsampled Alignment from the Quiver Alignment, thus in the ERQHD case the upsampling algorithm and perhaps the hardware itself may be shared for both purposes.

Note that according to the n-rature embodiment of the present invention, the number of detector images used may be increased from two to three or more, e.g., using detector images I_{A}, I_{B}, I_{C}, . . . .

### ERQHD Resampling

The resampling stage for ERQHD must be modified to operate directly on the I_{A} and I_{B} . . . images from the detector rather than the Quadrature Combined Image. Resampling of the Quadrature Combined Image for QHD or NHD may be performed in the same manner as resampling in a direct detection channel according to [2][4]. In this approach, the position of each SLM pixel image upon the detector is established by locating the positions of the reserved blocks within the page image. Resampling is then performed by choosing a set of detector pixel values I near to the SLM pixel image (e.g., the nearest 4×4 window of detector pixels), and applying a set of resampling coefficients w, i.e.,

\hat{d}=Iw (3)

where \hat{d} is the estimated data value d, of the SLM pixel image, e.g., dε{−1,+1} for BPSK data. Note that while dε{−1,+1}, d may assume non-integer values such as, e.g., 0.90, for subsequent soft error correction. w may be chosen to minimize the squared error between \hat{d} and the actual data, d, over many detection cases. Furthermore, differing w coefficient sets may be optimized and applied for differing alignment cases, e.g., 256 different w coefficient sets could be used corresponding to differing 2D fractional pixel alignment cases of the 4×4 window of detector pixels with respect to the SLM pixel image.

For ERQHD, the detector pixel values I in the Quadrature Combined Image may be replaced by the corresponding pixel values in the I_{A} and I_{B} detector images. For ERQHD n-rature detection, there may be additional images, e.g., C, etc., as well. Furthermore, the detected pixel values in these images may be modified, such as by subtracting a global image mean, etc., in accordance with a Detector Image Modification rule described in Detector Image Modification, below. Let the set of (modified) detector pixel values near the SLM pixel image be designated by Ã, \tilde{B}, \tilde{C}, etc. . . . . Then an ERQHD resampling procedure might be used,

\hat{d}=[c_{A}Ã+c_{B}\tilde{B}+c_{C}\tilde{C}+ . . . ]w (4)

where c_{A}, c_{B}, . . . represent the combination coefficients for the respective detector pixel value sets. In one embodiment, these combination coefficients may be determined by the cosine projection of the data page upon the local oscillator used to detect it as measured by the reserved block correlation peak strengths, e.g.,

$${c}_{A} = \frac{{P}_{A}}{\sqrt{{P}_{A}^{2} + {P}_{B}^{2} + …}} , \\ {c}_{B} = \frac{{P}_{B}}{\sqrt{{P}_{A}^{2} + {P}_{B}^{2} +}} , … \qquad ( 5 )$$

where P_{A}, P_{B}, . . . are the Upsampled A Peaks, B Peaks, etc., . . . for the corresponding SLM pixel image as determined from the reserved block correlation operations on the corresponding I_{A}, I_{B}, . . . detector images. In another embodiment, the normalizing denominators in the cosine projections may be omitted, e.g.,

C_{A}=P_{A}, C_{B}=P_{B}, (6)

In still other embodiments, the combination coefficients may be determined from the cosine projections of the reserved blocks from a different data page, e.g., when performing phase quadrature holographic multiplexing (see the description of Phase Quadrature Holographic Multiplexing below). For example, the data value of the corresponding SLM pixel in the I (inphase) data page could be estimated by applying equations (4) and (5) as presented, and then the data value of the corresponding SLM pixel image in the Q (quadrature) image could be estimated by using different combination coefficients, e.g.,

$${c}_{A} = cos ( {cos}^{- 1} ( \frac{{P}_{A}}{\sqrt{{P}_{A}^{2} + {P}_{B}^{2} + …}} ) - {φ}_{Q} ) , \\ {c}_{B} = cos ( {cos}^{- 1} ( \frac{{P}_{B}}{\sqrt{{P}_{A}^{2} + {P}_{B}^{2} + …}} ) - {φ}_{Q} ) , … \qquad ( 7 )$$

where φ_{Q} is the known phase difference between the I and Q images, e.g., 90°. In this manner separate correlation and upsampling operations do not need to be performed for the reserved block patterns in the Q image; instead the entire image combination and resampling process may be accomplished using the reserved block patterns of the I image. An I image is sometimes referred to a P image, such that an I and Q image pair can alternatively be referred to as a P and Q image pair. An I image of an I and Q image pair should not be confused with I_{A}, I_{B}, I_{C}, etc., which refer to intensities of image A, image B, image C, etc., respectively.

### N-Rature Homodyne Detection

In another embodiment of the present invention, n-rature homodyne detection (NHD) may be performed in lieu of quadrature homodyne detection (QHD). In QHD, two detector images, I_{A} and I_{B}, are acquired of each hologram. A phase difference, typically but not necessarily 90°, is introduced into either the signal beam or the local oscillator beam so that different projections (typically, but not necessarily, orthogonal) of the complex signal will appear in each detector image. In NHD, this process is generalized to use n detector images, I_{A}, I_{B}, I_{C}, etc., and a phase difference typically of 360°/n is introduced for each subsequent image. Though NHD requires additional holographic exposures, it enjoys other benefits, most notably the rejection of common intensity noise, as described below.

In traditional QHD, the detected images may be described by

I_{A}=I_{LO}+I_{S}+2|E_{LO}∥E_{S}|cos(Δφ)

I_{B}=I_{LO}+I_{S}+2|E_{LO}∥E_{S}|cos(Δφ+9°) (8)

where I_{S} is the signal intensity, I_{LO} is the local oscillator intensity, and Δφ is the phase difference between the two. |E_{S}| and |E_{LO}| are the magnitudes of the optical fields, i.e., |E_{S}|=\sqrt{I_{S}},|E_{LO}|=\sqrt{I_{LO}}. The quantities φ_{A}≈Δφ and φ_{B}≈Δφ+90° are measured using reserved block correlations, and then the signal magnitude |E_{S}| may be estimated by

$$\begin{matrix}\vert {\hat{E}}_{S} \vert = \frac{1}{2 \vert {E}_{LO} \vert} [ {I}_{A} cos ( {φ}_{A} ) + {I}_{B} cos ( {φ}_{B} ) ] \\ = \frac{1}{2 \vert {E}_{LO} \vert} \{ \begin{matrix}[ {I}_{LO} + {I}_{S} + 2 \vert {E}_{LO} \vert \vert {E}_{S} \vert cos ( Δ φ ) ] cos ( {φ}_{A} ) + \\ [ {I}_{LO} + {I}_{S} + 2 \vert {E}_{LO} \vert \vert {E}_{S} \vert cos ( Δ φ + 90 ° ) ] cos ( {φ}_{B} )\end{matrix} \} \\ \approx \vert {E}_{S} \vert ( {cos}^{2} ( Δ φ ) + {cos}^{2} ( Δ φ + 90 ° ) ) + \\ \frac{1}{2 \vert {E}_{LO} \vert} ( {I}_{LO} + {I}_{S} ) ( cos ( Δ φ ) + cos ( Δ φ + 90 ° ) )\end{matrix} \qquad ( 9 )$$

The final term in the last expression represents common intensity noise. Since the factor (cos²(Δφ)+cos²(Δφ+90°))=1 for all Δφ in the final expression, common intensity noise is an additive noise source in the estimate of |E_{S}|. Since, typically, I_{LO}<<I_{S} and I_{LO}≈constant for homodyne detection, common intensity noise is usually small compared to the signal. Common intensity noise may also be mitigated by Detector Image Modification as described subsequently. Nevertheless, the elimination of common intensity noise by n-rature detection has been shown to produce a significant SNR boost in laboratory tests.

For n=3, n-rature detection, the detector images may be written as

I_{A}=I_{LO}+I_{S}+2|E_{LO}∥E_{S}|cos(Δφ)

I_{B}=I_{LO}+I_{S}+2|E_{LO}∥E_{S}|cos(Δφ+120°)

I_{C}=I_{LO}+I_{S}+2E_{LO}∥E_{S}|cos(Δφ+240°) (10)

The reserved block phase measurements then become φ_{A}≈Δφ, φ_{B}≈Δφ+120° and φ_{C}≈Δφ+240°. Then |E_{S}| may be estimated by

$$\begin{matrix}\vert {\hat{E}}_{S} \vert = \frac{1}{3 \sqrt{{I}_{LO}}} [ {I}_{A} cos ( {φ}_{A} ) + {I}_{B} cos ( {φ}_{B} ) + {I}_{C} cos ( {φ}_{C} ) ] \\ = \frac{1}{3 \vert {E}_{LO} \vert} \{ \begin{matrix}[ {I}_{LO} + {I}_{S} + 2 \vert {E}_{LO} \vert \vert {E}_{S} \vert cos ( Δ φ ) ] cos ( {φ}_{A} ) + \\ [ {I}_{LO} + {I}_{S} + 2 \vert {E}_{LO} \vert \vert {E}_{S} \vert cos ( Δ φ + 120 ° ) ] cos ( {φ}_{B} ) + \\ [ {I}_{LO} + {I}_{S} + 2 \vert {E}_{LO} \vert \vert {E}_{S} \vert cos ( Δ φ + 240 ° ) ] cos ( {φ}_{C} )\end{matrix} \} \\ \approx \vert {E}_{S} \vert \frac{2}{3} ( {cos}^{2} ( Δ φ ) + {cos}^{2} ( Δ φ + 120 ° ) + {cos}^{2} ( Δ φ + 240 ° ) ) + \\ \frac{1}{2 \vert {E}_{LO} \vert} ( {I}_{LO} + {I}_{S} ) ( cos ( Δ φ ) + cos ( Δ φ + 120 ° ) + cos ( Δ φ + 240 ° ) ) \\ = \vert {E}_{S} \vert\end{matrix} \qquad ( 11 )$$

which demonstrates that the common intensity noise term has canceled. This approach may be generalized for any n>2 since

$${\sum }_{k = 0}^{n - 1} {cos}^{2} ( φ + 2 π \frac{k}{n} ) = \frac{n}{2} \qquad ( 12 )$$

will be the constant factor applied to the signal term, and

$${\sum }_{k = 0}^{n - 1} cos ( φ + 2 π \frac{k}{n} ) = 0 \qquad ( 13 )$$

will always be the factor canceling the common intensity noise term.

The n-rature combination of equation (11) may be applied to the detector images to produce an “n-rature resampled image,” or they may be applied within a resampling process to implement resampling n-rature homodyne detection in a manner analogous to Enhanced Resampling Quadrature Homodyne Detection Embodiments described above and illustrated in FIG. 5.

### Cancellation Forcing

In a refinement to the n-rature algorithm above, cancellation forcing may be employed. Note that the coefficients for combining the images in equation (11), cos(θ_{A}), cos(θ_{B}), and cos(θ_{C}), are determined by correlation operations on the detected images. Perfect common intensity noise cancellation occurs when these coefficients sum to zero, but this may not be the case in practice due to measurement noise or phase errors in the constituent images. In such a case, cancellation forcing may easily be practiced by adjusting the coefficients to sum to zero, for example by subtracting 1/n of the mean from each coefficient.

### Detector Image Modification

Coherent channel variants including but not limited to QHD, ERQHD, NHD and other variants, involve the detection and subsequent processing of images containing a superposition of a local oscillator with the signal of interest. It is usually (though not always) advantageous to modify these images by removing the contribution of non-signal terms before performing the subsequent processing. By convention, we designate the modified image with a tilde to distinguish it from the original detector image, e.g., I_{A}→Ĩ_{A}. This modification may be performed in several different ways. Typically, but not necessarily,

I_{A}=I_{LO}+I_{Sig}+2|E_{LO}∥E_{S}|cos(Δφ)

Ĩ_{A}=2|E_{LO}∥E_{S}|cos(Δφ) (14)

In a first embodiment, Ĩ_{A} is computed from I_{A} simply by subtracting the mean. Typically, I_{LO} is constant and I_{S} is comparatively small, so subtracting the mean does a fair job of approximating the third term.

In a second embodiment, this is generalized to performing a filtering operation on I_{A} to produce Ĩ_{A}. For example, a spatial high-pass filter typically subtracts not only the mean, but other slowly-varying components caused by, for instance, intensity variations in the local oscillator, which can improve performance compared to simply subtracting the mean.

In a third embodiment, the device subtracts a reference image generated by other means. This reference image can be generated analytically or empirically. In an embodiment, the reference image is generated simply by taking a detector image of the local oscillator in the absence of a signal. This local oscillator calibration image can be regenerated at varying intervals. In an embodiment, a local oscillator calibration image can be factory-configured and never changed throughout the operating life of a drive. In another embodiment, a fresh local oscillator calibration image is generated every time the drive begins a recovery operation, or whenever a predetermined condition is met. In some embodiments, a local oscillator calibration image is generated using the same local oscillator beam power and exposure time as will be used when it is applied. However, variations include a local oscillator calibration image that is trivially re-normalized to replicate desired exposure conditions.

These detector image modification embodiments are typically not mutually exclusive.

### Refocusing by Beam Propagation

In some embodiments, errors in the position of the detector with respect to the focal plane of the hologram are compensated by beam propagation algorithms. It is well known that the digitally-sampled complex optical field distribution at one transverse plane can be algorithmically transformed to that of another transverse plane by means of a beam propagation algorithm. Thus, in cases where a focus error exists, the out-of-focus detected image can be converted to an in-focus image if the focus error is known. In the case where the focus error is not known, the controller may iteratively try beam propagation refocusing using differing propagation distances, selecting that distance which maximizes, e.g., SNR or some other quality metric.

Refocusing by beam propagation is made possible by homodyne detection because the whole complex optical field is detected. The method is inapplicable for conventional direct detection.

### Advantages of Coherent Optical Data Detection and Coherent Channel Modulation

It is thought that a coherent holographic data channel typically enjoys advantages over a direct detection channel for two related groups of reasons. The first, the communication theory group of reasons has to do with advantages PSK signaling and coherent detection provide according to well-established tenets of communications theory. The second, the holographic recording physics group, encompasses benefits that accrue specifically to holographic recording, particularly in reduction of signal-induced holographic noise.

### Communications Theory Discussion

In the literature of coherent optical communications, it is often shown that a PSK-modulated system enjoys twice the detector sensitivity of a direct ASK system (designated 00K, on-off keying in [5]) in theory, and usually even more than that in practice. We shall not repeat that derivation here, but note that it corresponds to a 3 dB improvement in system SNR. [5]

A second advantage comes from linearization of coherent noise, and the rejection of out-of-quadrature noise. In a direct detection channel with signal amplitude A and circularly symmetric coherent Gaussian noise with variance σ², the mean and variance of the detected signal is [6]

[symbol]

x [symbol] =A²+2σ²

σₓ²=4σ²(A²+σ²) (15)

for which an SNR metric may be defined

$$\begin{matrix}{SNR}_{dire ct} ≡ \frac{〈 x 〉}{{σ}_{x}} = \frac{{A}^{2} + 2 {σ}^{2}}{2 σ \sqrt{{A}^{2} + {σ}^{2}}} \\ \approx \frac{A}{2 σ} ( for {σ}^{2} << {A}^{2} )\end{matrix} \qquad ( 16 )$$

For a coherent channel, however, amplitudes are detected rather than intensities:

$$〈 x 〉 = A \\ {σ}_{x}^{2} = {σ}^{2} \\ ⇒ {SNR}_{coherent} \approx \frac{A}{σ} \qquad ( 17 )$$

As this factor-of-two SNR improvement accrues in the amplitude (as opposed to intensity) domain, the result is a 6 dB improvement in SNR.

Many other factors enter into a complete accounting of the communications theoretical performance implications of coherent detection, but this simple first-order analysis indicates that substantial performance gains are available, consistent with practice of this invention.

### Holographic Recording Theory Discussion

Holograms for holographic data storage (HDS) are typically recorded near a Fourier plane of the SLM in order to minimize their areal footprint. For pure ASK modulation, however, fully half of the energy of the signal beam resides in the DC component, and hence half of the energy comes to a focus at a bright spot in the center of the Fourier plane. This and other properties of ASK modulation necessitate the use of a phase mask during recording [7][8], and moreover, the phase mask must typically be mounted to a motion stage to further reduce signal-induced noise between holograms. Elimination of the phase mask, which tends to be bulky and expensive, as well as a lens relay required to image it, greatly enhances the prospects for a compact, low-cost commercial design.

Signal-induced noise can be divided into two broad categories. The linear first-order category includes only those terms in the weak, linear regime for both recording modulation and diffraction. Intra-signal modulation noise is an important example of this—it can be shown that the DC component of a signal field results in noise terms that add coherently both within and between holograms, whereas non-DC components produce terms that add incoherently [9]. In this respect, embodiments of PSK modulation typically result in a dramatic reduction of noise compared to ASK modulation. The second category consists of higher order effects. An example of this is localized saturation of media response at intensity hot spots, such as the DC focus. Failure to record the DC component of an ASK signal field results directly in the loss of contrast between bright and dark pixels; for a PSK field it produces very little impairment at all. Intensity variation may also produce higher order effects via localized shrinkage and grating distortion.

### Results of Direct Detection, QHD, and NHD

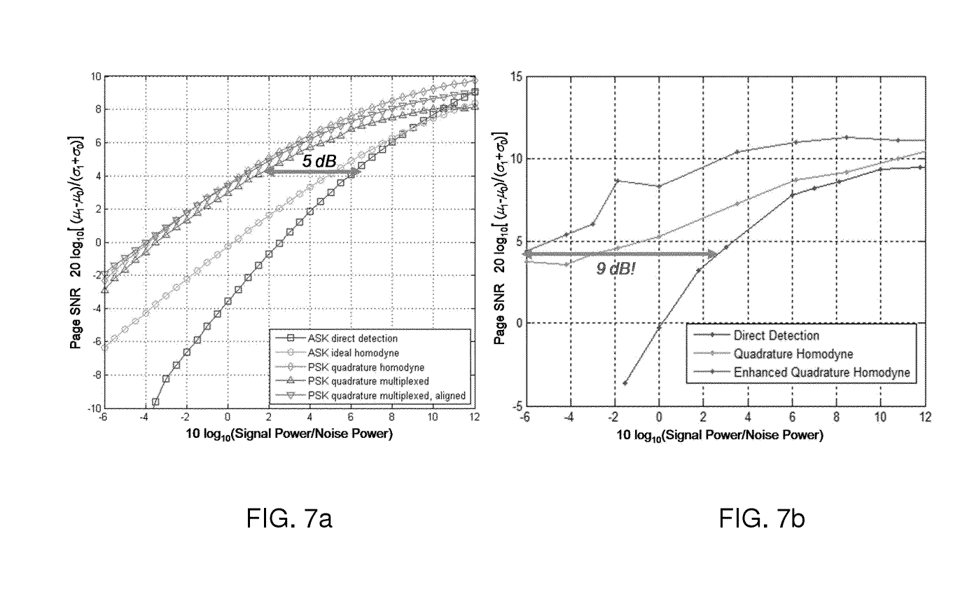

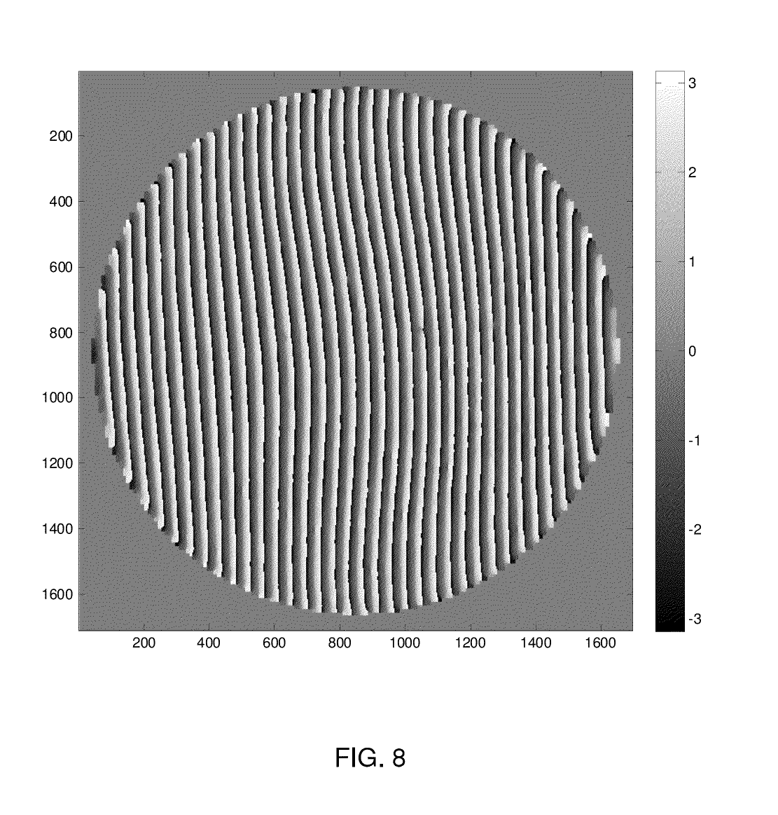

A comparison of performance of embodiments exemplifying direct, QHD, and NHD detection follows. For the purposes of the comparison, an SLM was illuminated with 405 nm laser light, and imaged on to a detector array with a pixel pitch ˜0.75 that of the SLM (4/3 oversampling). For an embodiment of direct detection, the SLM was configured for binary ASK modulation (i.e., bright and dark pixels). For QHD and NHD detection embodiments, the SLM was configured for binary PSK modulation (+180° phase pixels), and a collimated local oscillator beam with ˜30× intensity was mixed with the signal. A mirror in the local oscillator path was mounted to a piezoelectric actuator in order to effect the phase differences required by the QHD and NHD algorithms. Additionally, a portion of the laser light was diverted through a diffuser, and then blended with the signal beam in order to simulate coherent optical noise with a broad angular spectrum. The ratio of optical signal to optical noise power was varied across a test range, and detector images were collected and processed for all three detection variants. The results are summarized in FIG. 7b.

The curve labeled “Enhanced Quadrature Homodyne” in FIG. 7b shows n-rature detection with n=4; i.e., 4 images combined. The leftward shift of the n-rature curve compared to the direct detection curve represents the amount of optical S/N degradation NHD may suffer while still achieving the same performance. The 9 dB improvement shown over direct detection matches the theoretical prediction remarkably well. The results for QHD also match the predicted improvements (˜5 dB) in a simulation illustrated in FIG. 7a. NHD was not simulated in this data set.

These results reflect the improvements described under Communications Theory Discussion above, but not the holographic improvements described under Holographic Recording Theory, since no holography was actually involved.

### Local Oscillator Fringe Demodulation

The processes for QHD, ERQHD, and NHD all involve estimating the phase difference Δφ between the signal carrier and the local oscillator using reserved blocks distributed across the data page. In practice this method may perform poorly if Δφ varies too rapidly. Δφ manifests as a fringe pattern in the detected images, and aliasing will occur if the fringe pattern is not spatially sampled by the reserved block grid by at least the Nyquist frequency. Since many real-world perturbations tend to increase this fringe frequency, we have developed a set of methods collectively referred to as local oscillator fringe demodulation techniques.

### Medium Position Detection

Medium positioning errors during recovery tend to produce the largest impact on the Δφ fringe pattern in practice. In one embodiment, the recording medium is placed at or near a Fourier plane of the SLM. In such a geometry, we may describe the optical fields during a recovery operation as a Fresnel approximation using the well-known Fourier optics principle [10]

$$g ( x , y ) = {h}_{l} exp [ j π \frac{( {x}^{2} + {y}^{2} ) ( d - f )}{λ {f}^{2}} ] F ( \frac{x}{λ f} , \frac{y}{λ f} ) \qquad ( 18 )$$

where g(x,y) is the optical field at the detector and F(vₓ,v_{y}) is the Fourier transform of the recorded optical field as if it were emitted entirely from the recorded Fourier plane within the medium. By convention, the notation

$$F ( \frac{x}{λ f} , \frac{y}{λ f} )$$

denotes this Fourier transform scaled by x=λfvₓ and y=λfv_{y}. hₗ is a scalar factor, λ is the recording wavelength, and ƒ is the focal length of the Fourier transform lens (i.e., the recording objective lens). d is the propagation distance from the recorded Fourier plane to the lens, and x and y are the Cartesian coordinates at the detector.

Equation (18) represents the classical Fourier transform property of a lens, but also includes a quadratic phase factor that becomes significant when the recorded Fourier plane is not placed exactly in the lens focal plane, i.e., d≠ƒ. This condition represents a height (z axis) error of the position of the recorded hologram with respect to the optical head during recovery. Thus, measurement of Δφ using the techniques of this invention and extraction of the quadratic component (for example by projection onto a Zernike or Seidel basis) constitutes a highly accurate estimate of the medium height error. According to one embodiment of this invention, this error signal may be used to adjust the relative height of the medium during recovery. According to another embodiment, the error signal may be used to adjust a quadratic phase factor in a local oscillator or reference beam.

Similarly, transverse positioning errors (x and y axes) produce characteristic tilt factors in Δφ. According to the shift property of the Fourier transform,

$$f ( x - {x}_{0} ) {}^{𝒥} exp ( - j {k}_{x} {x}_{0} ) F ( {k}_{x} ) ,$$

shifting a function ƒ(x) by x₀ in the spatial domain introduces a phase factor of exp(−jkₓx₀) to its Fourier transform F(kx). Similarly, shifting in the y direction by y₀ introduces an exp(−jk_{y}y₀) factor. Thus, medium position errors in the x and y directions may be measured by extracting the respective tilt components. This may likewise be done with Zernike or Seidel coefficients, or by Fourier transform. According to embodiments of this invention, shift errors may be used to adjust the relative x,y position of a recording medium.

### 1.1 Local Oscillator Fringe Demodulation Algorithms

Given an estimate Δ\hat{φ} of Δφ produced by any means, a phase factor corresponding to Δ\hat{φ} may be demodulated (removed) from detected holographic images according to embodiments of this invention. Local oscillator fringe demodulation can serve to remove high frequency components of the local oscillator fringe pattern that would otherwise cause aliasing when sampled by data page reserved blocks, leading to degraded performance. Local oscillator fringe demodulation can thus be used to greatly improve tolerance to medium positioning errors, or to undesired components of Δφ introduced for any other reason, e.g., thermal distortion of the hologram, manufacturing tolerances, Bragg mismatches during hologram recovery, etc. Local oscillator fringe demodulation algorithms may be performed at different processing stages according to several embodiments of the invention.

### Detector Domain Local Oscillator Fringe Demodulation

Local oscillator fringe demodulation may be performed on the detected images. This may be performed at any stage while the images are still in the detector [det] resolution (as opposed to the [SLM] resolution), e.g., before coarse alignment determination (if any); after coarse alignment but before reserved block correlation operations; or after reserved block correlation operations. In practice, it is advantageous to perform detector domain local oscillator fringe demodulation before any coarse alignment or reserved block correlation operations, as those operations will benefit from fringe demodulation.

For QHD, detector domain local oscillator fringe demodulation may be performed by

I″_{A}=I_{A} cos(−Δ\hat{φ})+I_{B} sin(−Δ\hat{φ})

I″_{B}=I_{B} sin(−Δ\hat{φ})+I_{B} sin(−Δ\hat{φ}) (19)

where I′_{A} and I′_{B} are the demodulated versions of the raw images I_{A} and I_{B}, which subsequently may be processed according to the desired QHD or ERQHD algorithm. The effect of the −Δ\hat{φ} phase factor in each term is to largely cancel the existing Δφ within the raw images. For tilt fringe components, this is analogous to baseband demodulation of the carrier frequency from a frequency-modulated signal. The demodulated images retain a phase factor of the difference Δφ−Δ\hat{φ}. However, even if this difference is relatively large (i.e., the estimate is poor), it is likely to reduce the frequency of remaining fringe components, thus reducing the likelihood of fringe pattern aliasing in subsequent processing.

For NHD (including RNHD), the demodulation process is similar. For n=3:

I′_{A}=I_{A} cos(−Δ\hat{φ})+I_{B} cos(120°−Δ\hat{φ})+I_{C} cos(240°−Δ\hat{φ})

I′_{B}=I_{A} cos(−120°−Δ\hat{φ})+I_{B} cos(−Δ\hat{φ})+I_{C} cos(120°−Δ\hat{φ})

I′_{C}=I_{A} cos(−240°−Δ\hat{φ})+I_{B} cos(−120°−Δ\hat{φ})+I_{C} cos(−Δ\hat{φ}) (20)

Higher values of n are processed analogously. Different descriptions of these processes, perhaps including constant phase offsets or trigonometric functions, may be formulated without departing from the scope of the invention.

### N-rature to Quadrature Fringe Demodulation

The number of images may also be changed in the demodulation process. A particularly useful example of this principle is in the combination of three or more n-rature detection images into two images, which may subsequently be processed using QHD, rather than NHD, algorithms. For n=3:

I′_{A}=I_{A} Cos(−Δ\hat{φ})+I_{B} Cos(120°−Δ\hat{φ})+I_{C} Cos(240°−Δ\hat{φ})

I′_{B}=I_{A} Cos(−90°−Δ\hat{φ})+I_{B} Cos(90°−Δ\hat{φ})+I_{C} Cos(90°+240°−Δ\hat{φ}) (21)

Higher values of n are processed analogously. This version preserves the common intensity noise cancellation feature of NHD, while requiring less memory and computation in the later stages since the number of images has been reduced.
Δ\hat{φ} Estimation

An Δ\hat{φ} estimate of Δφ must be provided by some means. Typically, Δφ may contain frequency components higher than those that may be resolved by the reserved block sample grid, otherwise the extra demodulation step would not be necessary. Several methods may be employed according to different embodiments of the invention. In some embodiments, Δ\hat{φ} is represented as a function including samples corresponding to each pixel, or to groups of pixels. In other embodiments, Δ\hat{φ} is represented in non-sampled form, for example by Zernike or Seidel coefficients for components of interest. For example, Δ\hat{φ} might be represented compactly by three “position registers” indicating the tip, tilt, and focus terms of the wavefront corresponding to the medium positioning errors.

### Δφ Calibration Pages

In the first embodiment, special Δφ calibration holograms are interspersed among the data-bearing holograms of the recorded set. In the simplest embodiment of this technique, the calibration pages include a higher density of reserved blocks, and are thereby able to resolve higher fringe frequencies. For example, if a standard data page includes 8×8 pixel reserved blocks interspersed on a 64×64 reserved block sample grid, a calibration page could include reserved blocks of the same form on an 8×8 pixel grid. Such a calibration page would nominally consist of nothing but reserved blocks, and would be able to resolve spatial frequencies 8 times higher than a standard data page. The Δ\hat{φ} estimate could then be produced using methods almost entirely identical to the methods during ordinary QHD or NHD decoding.

For example, suppose the Δφ calibration page is recovered in QHD mode, i.e., using two detector images I_{A} and I_{B} with a phase difference of 90°. Then correlation operations on the calibration reserved block patterns are performed in the same manner as in original QHD, excepting for their greater number and density. This step produces correlation peak strength maps, for each of the images. The peak strength maps may then be upsampled from the reserved block resolution to the detector resolution following the original QHD method (refer to FIG. 5) to produce upsampled peak strength maps PA and P_{B}. Δ\hat{φ} may then be given as

Δ\hat{φ}=tan⁻¹(P_{B},P_{A}) (22)

where tan⁻¹ is the four-quadrant arctangent.

Δφ calibration pages are advantageously inserted so that Δ\hat{φ} may be recalculated any time Δφ is likely to change significantly. For books of angle-multiplexed holograms, for example, Δφ typically changes significantly when moving to a new book because of the mechanical uncertainty in the x,y (or r, θ in the case of a disk-shaped medium) movement (see the description of Medium Position Detection, above). Hence, it is advantageous to include a Δφ calibration page at the first recovery angle of each book. In one embodiment, a Δφ calibration page is recorded and recovered at the first angular address of each book, and the resulting Δ\hat{φ} estimate is used to demodulate all of the remaining pages in the book. In such an implementation, the overhead incurred by Δφ calibration pages is very low since there may be hundreds of holograms in a book. In other embodiments, the fraction of Δφ calibration page may be increased to provide redundancy, or to account for other sources of Δφ changes. For example, if x,y (or r, θ) mechanical moves are performed within a book (“short-stacking”), then a Δφ calibration page could be recorded at the first angular address of each short stack.

In some embodiments, the method for determining Δ\hat{φ} from a Δφ calibration page may differ from that of QHD. For example, a uniform Δφ calibration page could be recorded (i.e., all pixels in the same state), and the phase Δ\hat{φ} could be determined by well know methods used in interferometers. In other embodiments, larger or smaller reserved block patterns could be used, and multiple sizes could be used simultaneously. For example, a separate set of correlation operations could be performed on 4×4 pixel subsections of the reserved blocks to produce a higher-resolution, but noisier estimate of Δφ, and then this estimate could be combined with the standard-resolution estimate to produce a superior quality estimate. Lower-resolution but less noisy estimates could similarly be produced from larger patterns, e.g., 16×16 reserved block patterns.

### Δφ Least-Squares Fitting

In another embodiment, a Δ\hat{φ} estimate may be generated by performing a fitting operation, such as a least-squares fit, of available data points to a constrained Δ\hat{φ} function. For example, with respect to Medium Position Detection described above, the Δ\hat{φ} function could be constrained to include only tip, tilt and quadratic terms as would be expected from pure mechanical medium position errors. The available data points could be drawn from the reserved block correlations from an ordinary data page. The fit is performed accounting for the arbitrary piston term and the 2π phase wrapping that must appear in the reserved block measurement, but the full unwrapped version of would be used for the Δ\hat{φ} estimate. In this manner, a smooth, accurate quadratic estimate can be produced even if the wrapped fringe pattern exceeds the sampling resolution of the reserved block sample grid.

### Blind De-Aliasing

In still another embodiment, a higher-quality Δ\hat{φ} estimate may be generated by performing blind de-aliasing on an aliased Δ\hat{φ} estimate. For example, suppose an aliased Δ\hat{φ} estimate is produced by interpolating reserved block samples in an ordinary data page recovered with a large Δφ tilt component. In such a case, Δ\hat{φ} will exhibit a Fourier peak at a spatial frequency which is an aliased version of the true frequency. The set of true frequencies that will alias to the observed frequency is discrete; it becomes possible to blindly replace the observed frequency with candidates from this set and retry the page decoding operation. If the page can be correctly decoded according to CRC codes or similar integrity checks within the recorded data, then it can be concluded with a very high degree of confidence that the chosen candidate is correct. This procedure can be repeated with or without actually repeating holographic exposures until either the correct candidate is found, or until the set of reasonable candidates is exhausted.

### Numerical Refocusing

In another embodiment, a higher-quality Δ\hat{φ} estimate may be generated by performing numerical refocusing on an out of focus Δ\hat{φ} estimate. By “out of focus,” we here refer to a wavefront function with an intrinsic quadratic phase term of the form

$$exp [ j π \frac{( {x}^{2} + {y}^{2} ) ( d - f )}{λ {f}^{2}} ]$$

generated by a significant medium z positioning error, d−ƒ (see Medium Position Detection, above). The presence of such a phase term broadens the width of the Fourier transform of Δ\hat{φ}. It is possible to exploit this principle by iteratively applying candidate quadratic phase terms, and selecting one that reduces the width of the resulting Fourier distribution according to some metric, e.g., a variance calculation. This condition will obtain when the candidate quadratic phase term approximates the conjugate of the intrinsic phase term, thus refocusing Δ\hat{φ}.

### Adaptive Optical Fringe Demodulation

Fringe demodulation may also be effected by physically changing the wavefront of the local oscillator and/or signal beam to more closely match each other. In one embodiment, a beam steering means is used to adjust a tilt component of Δφ. In another, a beam focusing means is used to adjust a quadratic component of Δφ. In still another embodiment, an adaptive optics element, such as an SLM or a deformable mirror, is used to adjust an arbitrary component of Δφ as determined, e.g., by Zernike or Seidel coefficients.

### Predetermined Fringe Demodulation

Fringe demodulation Δ\hat{φ} estimates may also be predetermined and stored in drive controller memory. Predetermined wave fronts may be used directly for fringe demodulation, or they may be used in combination with any of the dynamic techniques of this section. For instance, a predetermined wavefront may be used as a Δ\hat{φ} estimate while demodulating a Δφ calibration page, with the resulting empirical Δ\hat{φ} estimate being summed with the predetermined wavefront to produce a refined estimate. Predetermined wave fronts may be generated by a factory calibration operation, such as by interferometry; or by mathematical modeling or simulation.

In one embodiment, an aberration function corresponding to the design-nominal or as-built performance of the optical system is used as a predetermined wavefront. This approach might enable the use of cheaper or smaller lenses or other optical components. In another embodiment, this wavefront may be further modified according to current conditions to account for environment (e.g., temperature), wavelength, etc. . . . .

In another embodiment, one or more predetermined wavefronts might be used to remove the known phase aberrations imparted by a phase mask. Phase masks are commonly used to mitigate the effects of the “DC hot spot” and inter-pixel noise in ASK-modulated data (see Holographic Recording Theory Discussion, above). Although the elimination of the phase mask is one of the motivating features of using PSK modulation according to U.S. Pat. No. 7,623,279 [1], the use of a phase mask along with the present predetermined wavefront method will allow the present invention to be practiced with ASK modulation; or allow other modulation schemes that might necessitate the use of a phase mask.

### Results of Local Oscillator Fringe Demodulation

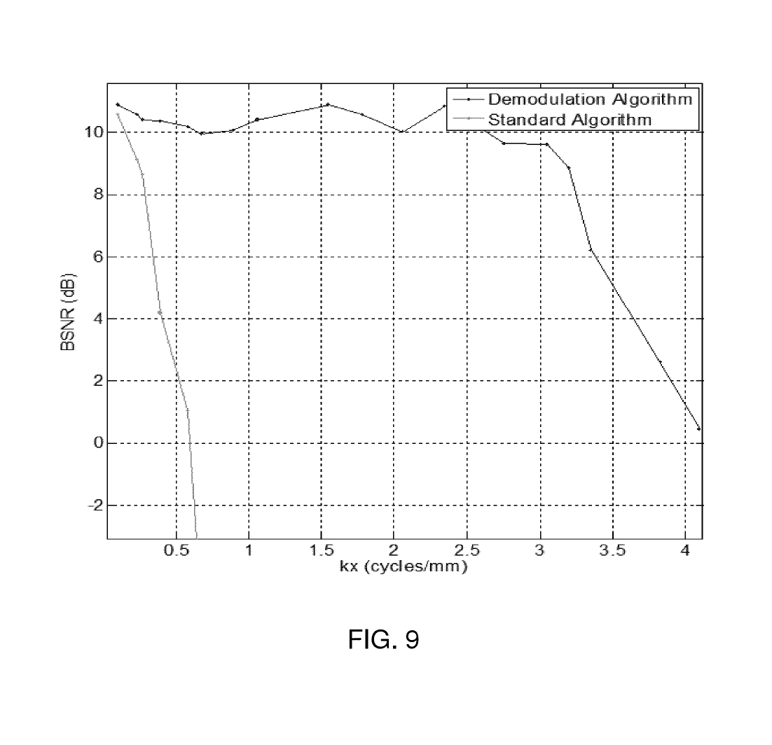

The apparatus used to compare direct detection, QHD, and NHD, the results of which are illustrated in FIG. 7b, was also configured to perform an embodiment of local oscillator fringe demodulation using the N-rature to Quadrature Fringe Demodulation process described above, applying a Δ\hat{φ} estimate derived from the Δφ Calibration Pages method described above. FIG. 9 shows a typical Δ\hat{φ} estimate derived from a Δφ calibration page, for a recovery condition with a large horizontal tilt component. It illustrates fringes at a pitch of about 3 cycles/mm, which corresponds to a 9 μm medium position error in an embodiment of an HDS device.

FIG. 9 shows the results of an embodiment where horizontal fringe frequency (kx) is varied, and n-rature (for n=4) recoveries are performed both with and without local oscillator fringe demodulation. Note that the SNR declines precipitously as the fringe pitch increases without fringe demodulation, but the curve with fringe demodulation exhibits little degradation until about 3 cycles/mm. A positioning accuracy of ±5 μm or better can be achieved in an embodiment using moderately-priced components. The ±5 μm or better accuracy is easily accommodated using the present algorithms.

### Signal Modulation

An important aspect of the present invention is the enabling of signal modulation techniques that are not possible or practical with traditional direct detection. We have already discussed some of the benefits accruing from the use of PSK modulation in Communications Theory Discussion and Holographic Recording Theory Discussion sections above. Other signal modulation techniques may be employed according to embodiments of the invention.

### Phase Quadrature Holographic Multiplexing

Phase quadrature holographic multiplexing (PQHM) is the analog of QPSK in traditional communications theory. The ability to detect the phase of a hologram presents an opportunity to increase storage density. A second hologram can be recorded with each reference beam (e.g., two holograms at each reference beam angle for angle multiplexing), and the holograms will not cross talk provided they have a 90° difference in phase. Thus, the PQHM provides a doubling of storage density, and opens the door to other advanced channel techniques. Furthermore, PQHM significantly improves both recording and recovery speeds.

### PQHM Recovery

According to a QHD method [1], a quadrature combined image is produced by combining the detected images

$$\begin{matrix}{\hat{E}}_{I} ( x , y ) = cos [ Δ φ ( x , y ) ] {\tilde{I}}_{A} ( x , y ) + sin [ Δ ( x , y ) ] {\tilde{I}}_{B} ( x , y ) \\ = \frac{{P}_{A} ( x , y )}{{( {P}_{A}^{2} ( x , y ) + {P}_{B}^{2} ( x , y ) )}^{1 / 2}} {\tilde{I}}_{A} ( x , y ) + \\ \frac{{P}_{B} ( x , y )}{{( {P}_{A}^{2} ( x , y ) + {P}_{B}^{2} ( x , y ) )}^{1 / 2}} {\tilde{I}}_{B} ( x , y )\end{matrix} \qquad ( 23 )$$

where Ê_{I} is the estimated optical field of the signal at the detector, Ĩ_{A} and Ĩ_{B} are the detected images (potentially modified as described under Detector Image Modification, above), and P_{A} and P_{B} are the upsampled peak strength maps. In this form, it is evident that the combination process constitutes a projection of the signal, captured in an arbitrary phase basis, back onto its originally-recorded phase basis.

The quadrature component of the signal can thus be found by projecting the signal onto a phase basis orthogonal to the first:

$$\begin{matrix}{\hat{E}}_{Q} ( x , y ) = - sin [ Δ φ ( x , y ) ] {\tilde{I}}_{A} ( x , y ) + cos [ Δφ ( x , y ) ] {\tilde{I}}_{B} ( x , y ) \\ = \frac{- {P}_{B} ( x , y )}{{( {P}_{A}^{2} ( x , y ) + {P}_{B}^{2} ( x , y ) )}^{1 / 2}} {\tilde{I}}_{A} ( x , y ) + \\ \frac{{P}_{A} ( x , y )}{{( {P}_{A}^{2} ( x , y ) + {P}_{B}^{2} ( x , y ) )}^{1 / 2}} {\tilde{I}}_{B} ( x , y )\end{matrix} \qquad ( 24 )$$

Ê_{I} and Ê_{Q} are traditionally referred to as the inphase and quadrature components of the signal. For the case of PQHM, independent holographic data pages may be written in each component, leading to the doubling of storage density. Furthermore, Ê_{Q} may be computed from the same detector images using the same upsampled peak strength maps used for Ê_{I}—it is not necessary even to perform correlation operations for the reserved block patterns in the Q page, which may differ from those in the I page. In this manner, a PQHM system is able to recover two data pages from two holographic exposures, achieving the same rate as direct detection.

In an alternative embodiment, the QHD recombination algorithm is performed twice independently to recover each of the signals. In this case, the reserved block cross-correlations must be performed using the known reserved block patterns of the Q page in addition to those of the I page. Q image recombination is performed using equation (23) with the Q reserved block pattern cross-correlation peak strengths. In another alternative embodiment, the cross-correlations for both known reserved block patterns are performed, and the results are combined into a single low-noise estimate of the detected phase basis, which is then used in the recombination of both images.

### N-Rature PQHM Recovery

The method of PHQM Recovery described above can be applied for QHD recovery and NHD combined with n-rature to quadrature fringe demodulation. For embodiments involving three or more images the expressions may be modified. For n=3:

$$\begin{matrix}\begin{matrix}{\hat{E}}_{I} = cos ( Δ φ ) {\tilde{I}}_{A} + cos ( Δφ - 120 ° ) {\tilde{I}}_{B} + cos ( Δ φ - 240 ° ) {\tilde{I}}_{C} \\ = \frac{{P}_{A}}{{( {P}_{A}^{2} + {P}_{B}^{2} + {P}_{C}^{2} )}^{1 / 2}} {\tilde{I}}_{A} + \\ cos [ {cos}^{- 1} ( \frac{{P}_{B}}{{( {P}_{A}^{2} + {P}_{B}^{2} + {P}_{C}^{2} )}^{1 / 2}} ) - 120 ° ] {\tilde{I}}_{B} + \\ cos [ {cos}^{- 1} ( \frac{{P}_{C}}{{( {P}_{A}^{2} + {P}_{B}^{2} + {P}_{C}^{2} )}^{1 / 2}} ) - 240 ° ] {\tilde{I}}_{C}\end{matrix} & ( 25 ) \\ \begin{matrix}{\hat{E}}_{Q} = cos ( Δ φ - 90 ° ) {\tilde{I}}_{A} + cos ( Δφ - 90 ° - 120 ° ) {\tilde{I}}_{B} + \\ cos ( Δ φ - 90 ° - 240 ° ) {\tilde{I}}_{C} \\ = cos [ {cos}^{- 1} ( \frac{{P}_{A}}{{( {P}_{A}^{2} + {P}_{B}^{2} + {P}_{C}^{2} )}^{1 / 2}} ) - 90 ° ] {\tilde{I}}_{A} + \\ cos [ {cos}^{- 1} ( \frac{{P}_{B}}{{( {P}_{A}^{2} + {P}_{B}^{2} + {P}_{C}^{2} )}^{1 / 2}} ) - 120 ° ] {\tilde{I}}_{B} + \\ cos [ {cos}^{- 1} ( \frac{{P}_{C}}{{( {P}_{A}^{2} + {P}_{B}^{2} + {P}_{C}^{2} )}^{1 / 2}} ) - 330 ° ] {\tilde{I}}_{C}\end{matrix} & ( 26 )\end{matrix}$$

Higher n may be accommodated analogously. Note that in these expressions, P_{A}, P_{B}, . . . correspond to the upsampled reserved block correlations for the I image reserved block patterns. One skilled in the art might, following the discussion of PHQM Recovery above, modify the expressions to instead employ correlations for the Q image reserved block patterns, or to incorporate both.

### PQHM Recording

Holographic recording is performed by illuminating a photosensitive medium with an interference pattern formed by two mutually coherent beams of light. In one embodiment, the light induces a refractive index change that is linearly proportional to the local intensity of the light, i.e.,

$$\begin{matrix}Δ n ( \vec{r} ) = S t I ( \vec{r} ) \\ = S t ( {\vert {E}_{R} ( \vec{r} ) \vert}^{2} + {\vert {E}_{S} ( \vec{r} ) \vert}^{2} + {E}_{R}^{*} ( \vec{r} ) {E}_{S} ( \vec{r} ) + {E}_{R} ( \vec{r} ) {E}_{S}^{*} ( \vec{r} ) )\end{matrix} \qquad ( 27 )$$

where Δn(\vec{r}) is the induced refractive index change, S is the sensitivity of the recording medium, t is the exposure time, and \vec{r}={x, y, z} is the spatial coordinate vector. I(\vec{r}) is the spatially-varying intensity pattern, which is in turn decomposed into a coherent summation of two underlying optical fields, E_{R}(\vec{r}) and E_{S}(\vec{r}), representing the complex amplitudes of the reference beam and the signal beam, respectively. The unary * operator represents complex conjugation.

### Sequential PQHM Recording

In one embodiment, the invention is practiced with angle-multiplexing and a page-oriented signal beam in a Fourier-transform geometry. In this case, both the reference beam and the signal beams corresponding to an individual stored bit are plane waves (or substantially resemble plane waves), though the invention can be practiced in virtually any page-oriented system. Generally, the reference and signal beams may be written as exp(jφ_{R})E_{R}(\vec{r}) and exp(jφ_{S})E_{S}(\vec{r}) respectively, where phases φ_{R} and φ_{S} have been explicitly factored out. Then,

Δn(\vec{r})=St[|E_{R}(\vec{r})|²+Re{exp(jΔφ)(E*_{R}(\vec{r})E_{S}(\vec{r})+E_{R}(\vec{r}))}] (28)

where Δφ=φ_{S}−φ_{R} is the difference between the phases of the two recording beams.

In this form it is evident that the phase of the interference term may be controlled by controlling the phase difference of the recording beams. If two holograms are recorded sequentially using the same reference and signal beams E_{R}(\vec{r}) and E_{S}(\vec{r}) while changing Δφ by 90°, then the holograms will have a quadrature relationship to each other. Each planar grating component in the Fourier decompositions of the interference terms of the two holograms will be identical to the corresponding component of the other hologram, excepting for a 90° phase difference. This reflects the fact that grating fringes of each component of the second hologram are actually shifted by 90° with respect to the first, and thus the recorded gratings are substantially spatially orthogonal to each other. Similarly, the two holograms will be reconstructed in quadrature when the medium is illuminated by an appropriate probe beam. Because their gratings are orthogonal, the two holograms actually occupy different degrees of freedom within the address space of the recording medium, even though they use the same bands of angular spectrum.

We denote the two quadrature-multiplexed holograms as the I hologram and the Q hologram (or the I quadrature and the Q quadrature of the same hologram). If the signal beams of the two sequentially-recorded holograms are not identical, but are instead modulated with two different data patterns, then the quadrature relationship can still be maintained so long as the modulation scheme does not produce substantial out-of-quadrature gratings within each individual hologram. For example, traditional binary ASK (amplitude shift keying) works for this purpose because if ‘ones’ are represented by gratings in the 0° phase in the I hologram, then in the Q hologram ‘ones’ can be represented by gratings in the 90° phase (with ‘zeros’ being represented by the absence of a grating in both cases). Similarly, for binary PSK modulation (phase shift keying, in one embodiment), ‘ones’ and ‘zeros’ are respectively represented by 0° and 180° gratings in the I hologram, and by 90° and 270° gratings in the Q hologram. Thus, in all cases, an orthogonal ±90° relationship is maintained between the I and Q gratings of each Fourier component.

Phase-quadrature recording may be physically effected by changing the optical path length of one (or possibly both) of the recording beams to produce the net phase difference of Δφ=90° (or ±90° plus some whole number of waves).

### Parallel PQHM Recording

In an alternative embodiment of the invention, a pair of quadrature-multiplexed holograms may be recorded during a single exposure. For this embodiment, the binary SLM must be replaced with an SLM capable of gray-scale modulation including at least the four states required to write the compound gratings that would be written by the sequential method. In one embodiment, QPSK modulation is employed, and the gray-scale SLM is capable of modulating each pixel into one of the four quadrature phase states of 0°, 90°, 180°, and 270°. In this case, the binary state of each pixel in both images together may be encoded into a single state of the gray-scale phase SLM in a manner that produces quadrature-multiplexed gratings indistinguishable from those produced by sequential writing. The single exposure for parallel quadrature recording requires only 1/\sqrt{2} of the optical energy required for the two exposures of the sequential method, so medium consumption (M/# usage) is reduced by a factor of 0.707. Recording rates may be increased by up to the same factor.

In other embodiments, the four states required of the gray-scale SLM might be implemented by cascading two or more binary SLMs in series, or by cascading non-binary SLMs in series to produce the required four phase/amplitude states. In embodiments employing modulation schemes different from the preferred binary PSK, the required four states might not correspond to the four quadratic states of 0°, 90°, 180°, and 270°. For example, parallel phase-quadrature recording of two binary ASK-modulated holograms might be accomplished with an SLM (or cascaded series of SLMs) capable of producing two bright states at phase 0° and 90° with 1/\sqrt{2} amplitude, a bright state at phase 45° with unity amplitude, and a dark state.

### PQHM Reserved Block Equalization

The reserved blocks used in the QHD process may serve other purposes as well. In one embodiment, the present invention is practiced using oversampled images, and the reserved blocks serve as fiducials for image alignment measurement [2]. Since the reserved block data patterns are known, they may also be used for signal-to-noise ratio (SNR) calculation[2]. The specific patterns employed for the reserved blocks may also be selected to eliminate or reduce reserved block pattern-dependent autocorrelation noise, and cross correlations may be calculated over a target pattern corresponding to only an interior region of the reserved block in order to prevent noise from neighboring data pixels from impacting the alignment measurement. In one embodiment of [2] (see column 19, lines 21-54), the 8×8 pixel binary reserved block pattern is designed such that the cross correlation of the inner 6×6 pixel sub-block with any of the other eight edge-bordering 6×6 pixel sub-blocks is zero. Similarly an interior region corresponding to the inner 6×6 pixel sub-block is used to derive the target pattern.

Quadrature homodyne detection benefits from these embodiments of [2] as well. In one embodiment, quadrature homodyne detection is practiced with oversampled detection, and so the same alignment accuracy improvements accrue. Additionally, quadrature homodyne detection benefits from improvements to the accuracy in measurement of Δφ due to these same embodiments. Reserved block pattern-dependent autocorrelation noise and neighboring data pixel noise impact the measurement of cross correlation peak strengths just as they impact the measurement of their positions, so reducing these noise sources benefits both measurements.

Quadrature multiplexing benefits from these embodiments as well. However, quadrature multiplexing may additionally suffer from quadrature cross talk noise between the reserved blocks of the I hologram and the corresponding reserved blocks of the Q hologram, since the detected images are generally superpositions of the two holograms. Accordingly, it is beneficial to select reserved block patterns that eliminate or reduce quadrature cross talk noise.

In some embodiments, the reserved block patterns for quadrature multiplexing are selected to meet constraints in addition to those of the present embodiments of [2] so that all indicated sources of noise are simultaneously eliminated or reduced. In one embodiment, quadrature cross talk noise is eliminated or reduced by imposing the following additional constraints: 1) The cross correlation between the inner 6×6 sub-block of each I reserved block pattern and all nine 6×6 sub-blocks of the corresponding Q reserved block pattern is zero; and 2) The cross correlation between the inner 6×6 sub-block of each Q reserved block pattern and all nine 6×6 sub-blocks of the corresponding I reserved block pattern is zero. These additional constraints are analogous to those that prevent autocorrelation noise within each reserved block.

In an alternative embodiment, autocorrelation noise is reduced by minimizing cross correlations between oversampled versions of regions of the reserved block patterns, rather than the original binary versions. In another embodiment, the cross correlations of simulated or empirically measured images are minimized. In yet another embodiment, cyclic redundant arrays are employed [11]. Many variants that do not depart from the scope of this invention are possible.

In yet another embodiment, the reserved block patterns in the I and Q pages are identical, resulting in the detection of Δφ with a 45° offset, i.e., halfway between the I and Q holograms, rather than aligned with the I (or alternatively, Q) hologram. In such a case the offset can be subtracted, and QHD performed as usual.

### Single Sideband Holographic Recording

In another embodiment of the invention, redundant spectral components of the holographic signal are removed. In one embodiment of single-sideband recording, the HDS device employs polytopic multiplexing [12], and the redundant spectral components are removed by occluding half of the polytopic aperture. Since the polytopic aperture is placed in a Fourier plane of the signal beam, the complex amplitude distribution in the plane is conjugate-symmetric about the origin, so long as the signal beam is real-valued (as it is ideally for binary modulation schemes including PSK and ASK). In real-world cases where the signal is not purely real-valued but is instead modulated onto a phase carrier that varies slowly across the image field (i.e., the signal is conjugate-symmetric about the phase carrier, rather than about 0° phase), the invention may still be practiced so long as the phase carrier can be resolved by the coherent detection method. In one embodiment employing QHD, this resolution is determined by the reserved block spacing.

In the present case, up to half of the Fourier plane may be blocked without removing signaling information, so long as at least one sideband of each frequency component is passed. In one embodiment, the half of the Fourier plane corresponding to negative frequencies in x or y (e.g., the bottom or left half of the polytopic aperture) is blocked.

Because the size of the polytopic aperture determines the spacing of books of holograms, halving the aperture area halves the effective size of each hologram, and thus doubles the recording density as determined by address space. However, this gain can be realized only if the phase of the signal can be detected. Coherent detection fulfills this role as described herein.

Single sideband recording utilizes grating phase in order to encode spectral redundancy, and therefore this signaling channel is not available to perform PQHM as well. While these two embodiments of the invention might be practiced together, the result will be cross-talk between the two holograms on a magnitude approaching the signal strength.

Single-sideband multiplexing introduces an imaginary component in the detected signal that is normally not present due to cancellation of the imaginary parts in the conjugate sidebands. All that is required to restore the original signal is to discard the imaginary part of the signal (as expressed in the recorded phase basis). In one embodiment, QHD is performed in its original form, thus isolating the recorded real component. In alternative embodiments, the original signal might be reconstructed by employing various other digital or optical operations to the same purpose.

### Higher-Order PSK

In another embodiment, this invention may be used to record and recover data modulated with higher-order PSK constellations. PSK encoding may be extended generally to incorporate any number of phase states—for example 8-PSK. In one embodiment, 8-PSK recording is performed by recording a data page composed using a gray-scale phase SLM with each pixel taking one of eight phase states, e.g., 0°, 45°, 90°, 135°, 180°, 225°, 270° or 315°. Higher order PSK holograms may be detected using a modified QHD or NHD algorithm. One skilled in the art will readily discern how to modify the relevant equations (e.g., equations (23) and (24)) to accommodate the extra phase states. Any number and distribution of phase states may be thus accommodated. In another embodiment, higher order PSK holograms are recorded sequentially using a binary phase SLM (0° and 180°), and a separate phase retarder in a manner analogous to the Sequential PQHM Recording method described above. One skilled in the art will readily devise multiple exposure sequences to implement a given signal constellation. Note, however, that for PSK orders higher than four, the sequentially-recorded images do not constitute independent binary data pages. 8-PSK, for example, requires the sequential exposure of four SLM images but yields only three bits per pixel of data (not four) since the number of data bits is equal to the log base 2 of the number of phase states.

### Quadrature Amplitude Modulation

In still another embodiment, this invention may be used to record and recover data modulated in both amplitude and phase. 16-QAM, for example, is a well-known method for encoding 4 bits per symbol using a constellation of typically 4×4 states uniformly spread in the I-Q plane. Generally, any digital QAM constellation may be recorded holographically using a phase and amplitude-modulating SLM capable of assuming the required states, or with a sequence of exposures of varying amplitude and phase using a binary phase SLM. One skilled in the art will readily discern how to modify the relevant equations (e.g., equations (23) and (24)) to accommodate the extra states. Any number and distribution of states may be thus accommodated.

### Partial Response Signaling

In another embodiment, this invention may be used in conjunction with partial response maximum likelihood (PRML) signaling. PRML is well known in the field of communications where it is used to increase the data rate of time-varying channels. A time-varying PRML channel transmits data symbols at a rate exceeding their duration, so that neighboring symbol responses overlap one another. The detector then recovers the original symbol sequence by deconvolving the channel response from the detected sample sequence using a technique such as the Viterbi or BCJR algorithm.

In holography, PRML signaling may be employed in two dimensions in the spatial domain rather than time. The optical response of neighboring SLM pixel images overlap one another (blur) when resolution is decreased. According to an inventive aspect of the invention, a coherent channel enables PRML signaling by linearizing the channel response by permitting the detection of optical amplitude instead of intensity. The superposition of overlapping pixel fields resembles a linear convolution that is amenable to PRML detection. The intensity function resulting from such a superposition does not.

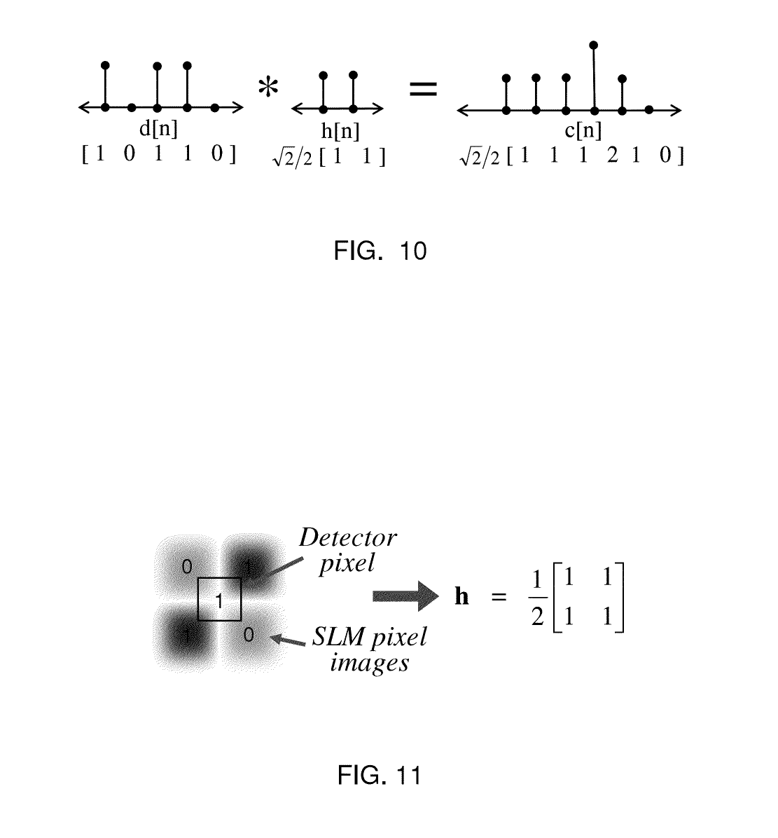

Perhaps the simplest form of partial response is variously called partial response class 1 (PR1) [13], or duobinary modulation [14]. The discrete channel response is conventionally represented by polynomial multiplication of the data sequence by 1+D, where D is the sample delay operator. Alternatively, the operation may be viewed as a discrete convolution by the response kernel h=\sqrt{2}/2[1 1], as illustrated in FIG. 10. The response to an ASK binary input, d[n]ε{0, 1}, thus consists of a ternary signal taking the values c[n]ε\sqrt{2}/2{0, 1, 2}.

The discrete response sequence of FIG. 10 can arise as the result of sampling an underlying continuous waveform. However, it is desirable to equalize and sample this waveform so that the sampled output closely conforms to the target response. Note also that the factor of \sqrt{2}/2 in the kernel serves to normalize the total energy per symbol to one when the signal units are amplitudes.

For the page-oriented channel of HDS, a two dimensional response may be used. FIG. 11 illustrates an embodiment of a 2D target response, dubbed PR1-2D. It is simply the two dimensional generalization of the standard PR1 response.

A pixel-matched system implementing this response would be implemented by aligning the detector pixels to the corners of SLM pixels, where the four fields overlap, rather than their centers (shown in FIG. 11). However, as described in detail in [1] and [2], a pixel-matched HDS system is largely impractical for general use. In order to implement the system with an oversampled detector, the corner alignment is performed algorithmically using a modified version of the resampling method of [1]. The original full response oversampling method uses the 4×4 detector pixel window closest to each SLM pixel image and applies coefficients optimized to determine the state of that SLM pixel alone; the new partial response resampling method selects the 4×4 detector pixel window closest to the corner of four SLM pixel images and applies coefficients optimized to determine the sum of the four SLM pixel responses. Coefficients are determined by simulation using a modified version of the computer code that derived the full response resampling coefficients.

### Optical Equalization for PRML

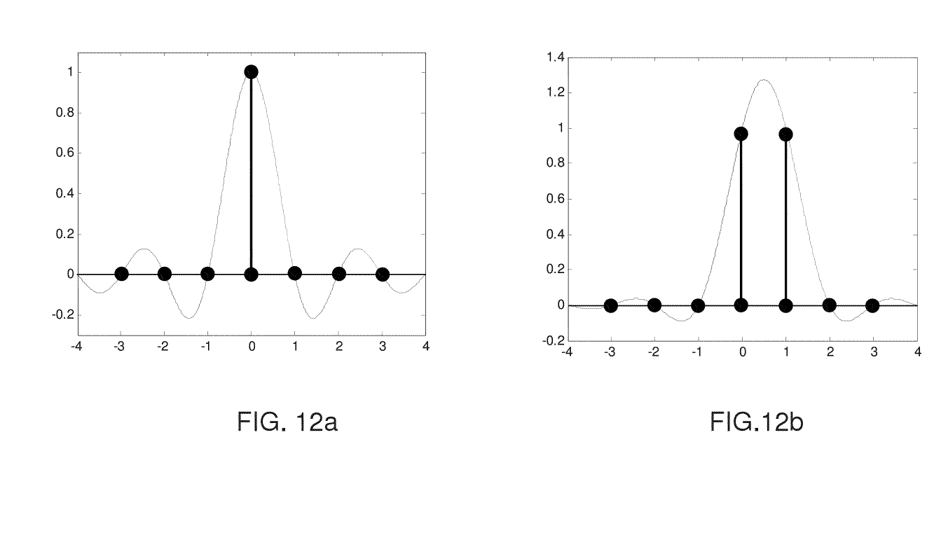

Imaging through a square polytopic aperture in the Fourier plane produces a sinc-shaped point spread function (a.k.a. impulse response) in the image plane. A sinc function is the lowest-bandwidth response that leads to an isolated non-zero value at the sampling point x=0, but zero at all other integer sampling points. That is to say, a sinc function naturally conforms to the desired discrete response h=[1] for a full response channel, rather than a partial response channel. In order to effect the desired discrete partial response shape of h=[1 1] (considering only one dimension for simplicity), a minimal bandwidth channel consisting of two displaced sinc functions can be used, as shown in FIGS. 12a and 12b. FIG. 12a illustrates a single sinc response of a rectangular aperture and FIG. 12b illustrates a double sinc response of an equalized aperture.

The PR1-2D point-spread function may be physically realized in an HDS system by apodizing the transmittance function of the polytopic aperture. The optical field transmittance function, t(x), across the aperture (as opposed to the intensity transmittance function) should resemble the Fourier transform of the desired point spread function h(x). For an aperture operating exactly at the spatial Nyquist frequency required to resolve the modulated data pattern, the expression is:

$$\begin{matrix}h ( x ) = sin c ( \frac{x - 1 / 2}{{Δ}_{pix}} ) + sin c ( \frac{x + 1 / 2}{{Δ}_{pix}} ) \\ = sin c ( \frac{x}{{Δ}_{pix}} ) * [ δ ( x + \frac{{Δ}_{pix}}{2} ) + δ ( x - \frac{{Δ}_{pix}}{2} ) ] {}^{𝒥} t ( x ) \\ = rect ( \frac{{Δ}_{pix} x}{λ f} ) cos ( 2 π \frac{{Δ}_{pix} x}{λ f} ) ,\end{matrix} \qquad ( 29 )$$

where Aₚᵢₓ is the SLM pixel spacing, λ is the wavelength of the light, and ƒ is the Fourier transform lens focal length. (Again, only one dimension is considered for simplicity.)

This is to say that the square aperture should be apodized with a single null-to-null cosine half-cycle in amplitude transmittance, which corresponds to cos² in intensity transmittance. An embodiment using a phase conjugate polytopic architecture employs a double pass through the polytopic aperture (once upon recording, and then again upon read-out), so the correct expression for the intensity transmittance, T(x), of the aperture becomes

$$T ( x ) = rect ( \frac{{Δ}_{pix} x}{λ f} ) cos ( 2 π \frac{{Δ}_{pix} x}{λ f} ) . \qquad ( 30 )$$

Note that the width of this aperture, determined by the

$$rect ( \frac{{Δ}_{pix} x}{λ f} )$$

factor, is half that of a full response polytopic aperture also operating at Nyquist. The area of the polytopic aperture determines book density in polytopic multiplexing [12], so a two-dimensional system will thus require only one fourth the area of a full response system, quadrupling recording density.

Having produced an optical response resembling the desired PR1-2D target, the data may be decoded using a two-dimensional version of the Viterbi or BCJR algorithm.

In one embodiment, the algorithm employed is the Iterative Multi-Strip algorithm [15].

In other embodiments, one skilled in the art will readily recognize how to modify the foregoing analysis to implement other partial response classes, e.g., PR2 (response (1+D)²), or EPR2 (response (1+D)³). Similarly, one skilled in the art will readily see how to implement noise-predictive maximum-likelihood detection (NPML).

### ALTERNATIVE EMBODIMENTS AND VARIATIONS

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

### REFERENCES

The references cited below are incorporated herein by reference, in their entirety, for all purposes.
[1] M. R. Ayres, U.S. Pat. No. 7,623,279, Method for holographic data retrieval by quadrature homodyne detection, Nov. 24, 2009.
[2] M. R. Ayres, A. Hoskins, K. R. Curtis, U.S. Pat. No. 7,848,595, Processing data pixels in a holographic data storage system, Dec. 7, 2010.
[3] M. R. Ayres, Signal Modulation for Holographic Memories, Ph.D. Dissertation, University of Colorado, (2007).
[4] M. Ayres, A. Hoskins, K. Curtis, “Image oversampling for page-oriented optical data storage,” Applied Optics, Vol. 45, No. 11, pp. 2459-2464, Apr. 10, 2006.
[5] B. E. A. Saleh, M. C. Teich, Fundamentals of Photonics, John Wiley & Sons, Inc., pp. 909-913, (1991).
[6] C. Gu, G. Sornat, J. Hong, “Bit-error rate and statistics of complex amplitude noise in holographic data storage,” Opt. Lett. 21, 1070-1072 (1996).
[7] C. B. Burckhardt, “Use of a Random Phase Mask for the Recording of Fourier Transform Holograms of Data Masks,” Appl. Opt. 9, 695-700 (1970).
[8] M.-P. Bernal, et al., “Effects of multilevel phase masks on interpixel cross talk in digital holographic storage,” Appl. Opt. 36, 3107-3115 (1997).
[9] M. R. Ayres, R. R. McLeod, “Intra-signal modulation in holographic memories,” ISOM/ODS 2008, Waikoloa, Hi. (July 2008).
[10] B. E. A. Saleh, M. C. Teich, Fundamentals of Photonics, John Wiley & Sons, Inc., pp. 118-119, (1991).
[11] D. Calabro, J. K. Wolf, “On the Synthesis of Two-Dimensional Arrays with Desirable Correlation Properties,” Info. and Ctrl. 11, 537-560 (1968).
[12] K. Anderson, K. Curtis, “Polytopic multiplexing,” Opt. Lett. 29, 1402-1404 (2004).
[13] W. E. Ryan, B. M. Zafer, “A Study of Class I Partial Response Signaling for Magnetic Recording,” IEEE Trans. Mag., 33, 4543-4550 (1997).
[14] I. Lyubomirsky, B. Pitchumani, “Impact of Optical Filtering on Duobinary Transmission,” IEEE Phot. Tech. Lett., 16, 1969-1971 (2004).
[15] M. Marrow, “Detection and Modeling of 2-Dimensional Signals,” Ph.D. dissertation, University of California, San Diego (2004).

We claim:

1. A method for use with a storage medium that holographically stores information, the method comprising the operations of:
(a) generating a reconstructed data beam by directing a first coherent light beam into a storage medium, wherein the first coherent light beam reproduces a reference beam used to holographically store information in the storage medium;
(b) obtaining a first image from a first combined beam produced by combining at least a portion of the reconstructed data beam with at least a portion of second coherent light beam, wherein the reconstructed data beam and the second coherent light beam have a phase difference that is a first phase difference; (c) obtaining a second image from a second combined beam produced by combining the reconstructed data beam with the second coherent light beam, wherein the phase difference of the reconstructed data beam and the second coherent light beam has been adjusted to produce a second phase difference;
(d) obtaining a third image from a third combined beam produced by combining the reconstructed data beam with the third coherent light beam, wherein the phase difference of the reconstructed data beam and the third coherent light beam has been adjusted to produce a third phase difference;
(e) processing the first image and second image and third image to obtain first image contrast information and second image contrast information and third contrast information; (f) obtaining combined information from the first image and second image and third image using the first image contrast information and the second image contrast information and the third image contrast information; and
(g) processing the combined information to obtain the information holographically stored by the storage medium.

2. The method of claim 2, wherein said obtaining combined information from the first image, the second image, and the third image using the first image contrast information, the second image contrast information, and the third image contrast information comprises substantially canceling common intensity noise in the combined information.

3. A method for fringe demodulation with a coherent detection system, the method comprising the operations of:
(a) generating an estimate of a fringe function to be demodulated;
(b) obtaining at least a first image and a second image;
(c) processing at least the first image and the second image to obtain at least a first demodulated image using the estimate of the fringe function to be demodulated.

4. The method of claim 3, wherein said generating an estimate of a fringe function to be demodulated comprises:
(a) holographically storing a calibration page in a storage medium;
(b) generating a reconstructed calibration beam by directing a first coherent light beam into the storage medium, wherein the first coherent light beam reproduces a reference beam used to holographically store the calibration page;
(c) obtaining a first image from a first combined beam produced by combining at least a portion of the reconstructed calibration beam with at least a portion of second coherent light beam, wherein the reconstructed calibration beam and the second coherent light beam have a phase difference that is a first phase difference;
(d) obtaining a second image from a second combined beam produced by combining the reconstructed calibration beam with the second coherent light beam, wherein the phase difference of the reconstructed calibration beam and the second coherent light beam has been adjusted to produce a second phase difference;
(e) processing the first image and second image to obtain first image contrast information and second image contrast information;
(f) obtaining combined information from the first image and second image using the first image contrast information and the second image contrast information; and
(g) processing the combined information to obtain the estimate of the fringe function to be demodulated.
